(19) United States
(12) Patent Application Publication
(10) Pub. No.: US 2017/0116618 A1
(43) Pub. Date: Apr. 27, 2017

(54) Object Usage Analytics

(71) Applicant: Adobe Systems Incorporated, San Jose, CA (US)

(72) Inventors: William Brandon George, Pleasant Grove, UT (US); Kevin Gary Smith, Lehi, UT (US)

(21) Appl. No.: 14/920,502

(22) Filed: Oct. 22, 2015

(51) Int. Cl. G06Q 30/02

(52) U.S. Cl. CPC G06Q 30/0201

(57) ABSTRACT

Object usage analytics are described. In one or more implementations, a digital medium environment is described in which sensors are included as part of objects, detect usage events that result from object usage, and produce sensor data indicative of the events. In this digital medium environment, a method is described of efficiently aggregating the sensor data and accurately making a determination of object usage from the aggregated sensor data to answer queries regarding the object usage that are made by users via analytics tools of a cloud reporting platform. Sensor data is obtained for an object that describes a usage event of the object. Once obtained, the sensor data is converted into aggregated usage data that is aggregated with other usage data of the object and maintained in the cloud reporting platform. The cloud reporting platform exposes analytics tools, which can provide users with a variety of information describing object usage. Using these tools, users make queries for information regarding usage of objects. In response to receiving such queries, answers are generated to present information that describes usage of the object to the user via the analytics tool.

### BACKGROUND

The ever expanding capabilities of digital properties, such as web sites and applications, include functionality to monitor user interaction with the properties and produce data indicative of the interaction. The digital nature of these properties are capable of producing rich, granular, structured data that describes user interaction. In many cases, the digital properties provide this data to cloud analytics systems where the data is aggregated. Doing so allows for subsequent analysis of an entire set of the digital-property interaction data that is aggregated by the cloud analytics system.

However, conventional cloud analytics techniques do not provide tools for analyzing “real-world” consumer products, such as cars, shoes, and so forth, in a similar manner. Broadly speaking, conventional techniques do not produce rich, granular, structured data that describes use of real-world consumer products, especially data that can be used to describe product use in an aggregate fashion across consumers. Consider a pair of shoes, for example. Outside of data that may be collected on occasion through manual surveys and reviews, data about a pair of shoes generally is not collected. This is the case for the vast majority of consumer products. Consequently, analytics tools provide a limited amount of information about the usage of real-world products. This limited information can result in businesses failing to understand how their products are used and effects of use on their products.

### SUMMARY

Object usage analytics are described. In one or more implementations, a digital medium environment is described in which sensors are included as part of objects, detect usage events that result from object usage, and produce sensor data indicative of the events. In this digital medium environment, a method is described of efficiently aggregating the sensor data and accurately making a determination of object usage from the aggregated sensor data to answer queries regarding the object usage that are made by users via analytics tools of a cloud reporting platform. Sensor data is obtained for an object that describes a usage event of the object. Usage events are detected by sensors with which the object is configured to monitor certain parts of the object for usage.

Once obtained, the sensor data is converted into aggregated usage data that is aggregated with other usage data of the object and maintained in the cloud reporting platform. The cloud reporting platform enables users to access this data by exposing the analytics tools, which are capable of providing a variety of information that describes object usage. By way of example, the analytics tools can include a freeform query and segmentation tool, a path and sequencing tool, an anomaly detection tool, a contribution analysis tool, a cohort analysis tool, and so on. Using these tools, users can make queries for information that describes usage of an object. In response to receiving such a query, an answer is generated to present the information that describes the usage of the object to the user via the analytics tool. The generated answer is then communicated for receipt by the user. In one or more implementations, the user is then presented with the generated answer through an interface of the analytics tool. The manner in which the information is presented can depend on the information requested in the query and the particular tool utilized. In some cases, for instance, the generated answer can be presented as a graph.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of a digital medium environment in an example implementation that is operable to employ object usage analytics techniques described herein.

FIG. 2 is an illustration of the digital medium environment in another example implementation that employs object usage analytics techniques.

FIG. 3 depicts a system in the digital environment of FIG. 1 for answering queries that request information about object usage and are made by users via analytics tools exposed by a cloud reporting platform.

FIG. 4 depicts an example of a user interface that is generated according to a query answer to present information that describes object usage to a user via an analytics tool.

FIG. 5 is a flow diagram depicting a procedure in an example implementation in which sensor data obtained for an object is aggregated and maintained in a cloud reporting platform, and in which a query made for information about the object via an analytics tool of the cloud reporting platform is answered.

FIG. 6 is a flow diagram depicting a procedure in an example implementation in which a selected analytics tool of a cloud reporting platform is used to make a query for information regarding object usage and in which an answer regarding the object usage is received and output.

FIG. 7 illustrates an example system including various components of an example device that can be implemented as any type of computing device as described and/or utilized with reference to FIGS. 1-6 to implement embodiments of the techniques described herein.

### DETAILED DESCRIPTION

### Overview

Conventional cloud analytics techniques provide a limited amount of information, if any, about the usage of “real-world” products, such as cars, shoes, and so forth. Rather conventional cloud analytics techniques are limited to use in relation to digital properties, such as web sites and applications. Largely, this is because real-world products are not equipped with functionality to produce rich, granular, structured data to describe their use. Instead, the data collected about use of real-world products is often limited to collection through manual surveys and reviews. As a result, businesses can fail to understand how their products are actually used and the effects of use on their products.

Consider an example in which an individual has car troubles. Onboard many cars is a diagnostic computer that can be connected to a specialized device capable of obtaining diagnostic information from the car. As part of diagnosing the troubles the individual is having with the car, this diagnostic information is obtained, e.g., at an auto repair shop. However, this information is not usually sent to a manufacturer of the car. Even if some diagnostic information is sent to car manufacturers from time to time, granular usage, performance, and problem information is not sent. This scenario is illustrative of the reality that many manufacturers face, which is that they simply do not have data describing problems that arise with their products that are actually being used or, importantly, data describing conditions that lead to those problems. Even in cases in which some usage and diagnostic information is reported (e.g., as can be the case for certain electronic devices), conventional techniques do not expose analytics tools that allow users to examine, play with, or perform statistical computations on data that describes the use of real-world products in a scalable and consumable fashion.

With the advent of the Internet of Things (IoT), however, data can be collected about objects that describes object use in a similar manner as data that is collected about digital properties describes the use of those digital properties. Implementation of the IoT involves configuring products (e.g., devices, food, clothes, sporting equipment, automobiles, and so on) with sensors so that data indicative of product usage is collected. This allows IoT-based data to be captured for an object that provides a more robust representation of the object's use (e.g., through rich, granular, structured data describing use of the object) than conventional techniques do.

Object usage analytics are described. In contrast to collecting limited data about objects used by consumers (e.g., through manual surveys and reviews), the techniques described herein enable the collection, aggregation, and analysis of data describing object usage that is rich, granular, and structured using the IoT. By using the IoT, data packets with web-like structure that describe object usage are communicated to a cloud reporting platform where that data is efficiently aggregated. The aggregated data set enables accurate determinations of object usage to be made. Further, by using information collected through the IoT about object use and which is maintained by such a cloud reporting platform, businesses can determine how their products are actually used, effects of use on those products, problems with those products, conditions which lead to the problems, and so on.

Consider an example in which a user has a car that is configured for the IoT. By “configured for the IoT” it is meant that this object is configured with sensors that detect usage events that result from usage. For instance, brakes of the car can be configured with sensors to detect usage events which result from the brakes being used, e.g., that a driver is pushing a brake pedal to slow down the car, that a braking system of the car is automatically engaging the brake, that the driver is releasing the brake pedal, that the braking system of the car automatically releases the brake pedal, and so on. In a similar manner, a radiator and water pump of the car can be configured with sensors to detect usage events associated with the radiator and water pump, such as actions to monitor a coolant level of the radiator, actions of the water pump to push coolant from the radiator, and so on. Broadly speaking, objects of the IoT can be configured with multiple sensors—one or more sensors for each part of the object that is to be monitored.

Responsive to detection of the usage events, the sensors included as part of the objects produce sensor data describing those events. For example, in response to detection of a driver pushing a brake pedal to slow down a car, sensors of the brakes produce sensor data that describes the braking, such as when it was performed (e.g., by associating a timestamp with the braking), whether the braking was initiated by the driver or a braking system of the car, an amount of pressure applied to slow down the car, an amount of time the pressure was applied, the weather when the braking was performed, and so on.

The data describing the usage events is then provided for aggregation and analysis. By way of example, sensor data, configured as data packets produced by the sensors of the car in response to detection of usage events, is uploaded (e.g., via the Internet) to a cloud reporting platform implemented by a service provider. There, the sensor data is converted into aggregated usage data and aggregated with other usage data. In the continuing example, usage data from a data packet produced by sensors of a car's brakes is aggregated with other usage data from the car's brakes as well as with usage data from other systems of the car. The aggregated usage data is then maintained by the cloud reporting platform.

Users, such as manufacturers, can access the aggregated usage data that describes usage of sensor configured objects using cloud analytics tools exposed by the cloud reporting platform. By way of example, the cloud reporting platform may expose a variety of analytics tools that users can access (e.g., through a browser interface) and that allow the users to examine, play with, and perform statistical computations, on the aggregated object usage data. The analytics tools can include freeform query and segmentation tools, path and sequencing tools, anomaly detection tools, contribution analysis tools, cohort analysis tools, and so on. In contrast to conventional techniques, these analytics tools allow businesses to see how a product actually performs, as usage data is aggregated for an entire set of users that use a product. In other words, the analytics tools, which report usage data that is aggregated for the entire set of users and across a variety of conditions in which the objects are actually used, can help businesses understand how their products are used and effects of use on those products. Consequently, the techniques described herein allow businesses to make more informed decisions about product development than traditional techniques.

As used herein, the term “object” refers to a good that is usable by an individual and which can be configured or packaged with sensors to detect usage events that result from use and produce data indicative of the detected events. Examples of objects include devices, e.g., mobile phones, landline phones, tablet devices, desktop computing devices, televisions, set top boxes, stereo receivers, digital video disc (DVD) players, digital music players, GPS receivers, gaming consoles, gaming controllers, entertainment systems, navigation systems, cameras, device peripherals such as a mouse, keyboard, headphones, stylus, speakers, and so on. Such devices can be configured or packaged with sensors in a variety of ways. For example, the packaging of such devices can include sensors to detect whether the packaging has been opened, electronic sensors can be embedded as part of the devices to communicate with the devices about their usage (e.g., connectively coupled to a device bus, circuits, and so on of the devices), electronic sensors can be embedded as part of the devices to communicate with other devices about usage (e.g., using short or long range communication technologies), sensors can be attached to the devices using adhesives (e.g., the sensors can be included as part of stickers placed on the devices), and so forth.

Food items are other examples of objects, and can include perishable items (e.g., meats, poultry, game, vegetables, fruits, dairy, eggs, and so on), non-perishable items (e.g., canned vegetables, canned meats, canned soups, canned fruit, food items in jars, and so on), processed foods (e.g., pasta, bread, condiments, pre-packaged meals, desserts, chips, crackers, and so on), beverages (e.g., soda, coffee, tea, alcoholic beverages, sports drinks, and so on), baking goods (e.g., flour, sugar, oils, vinegars, spices, and so on), and so forth. Food items can also be configured or packaged with sensors in a variety of ways. For example, the packaging of food items can include sensors (e.g., meat that is packaged to sit on a Styrofoam tray and wrapped in plastic wrap can have a sensor included as part of a sticker placed on the plastic wrap—one capable of providing a variety of information about usage of the meat, such as whether a temperature of the meat has surpassed a threshold temperature for a threshold amount of time associated with spoilage, a number of days remaining until the meat should be thrown out; twist ties used to bundle vegetables can be configured with sensors; sensors can be attached to or embedded in boxes, bottles, jars, cans, and containers used to package food—to provide a variety of information about the food packaged therein such as an amount of the food remaining, a number of days until the food is spoiled, and so forth), sensors can also be affixed directly to food items (e.g., sensors included as part of stickers can be attached to pieces of fruit, vegetables, and so on), and so forth.

Appliances are other examples of objects and can include refrigerators; freezers; convection/conventional ovens; microwave ovens; dishwashers; washers and dryers; ranges and cooktops; small kitchen appliances (e.g., coffee makers, tea makers, espresso makers, blenders, juicers, mixers, toasters, toaster ovens, pots and pans, slow cookers, crock pots, roaster ovens, food processors, and so on); kitchen gadgets (e.g., utensils, serving utensils, cutlery, and so on); heating, cooling, and air quality appliances (e.g., heaters, fireplaces, fans, air conditioners, air purifiers, humidifiers, dehumidifiers, thermostats, and so on); vacuum cleaners and floor care appliances; and so forth. In a similar manner as devices, appliances can configured or packaged with sensors in a variety of ways to ascertain their usage. For example, the packaging of appliances can include sensors to detect whether the packaging has been opened, electronic sensors can be embedded as part of the appliances to communicate with appliance firmware about their usage (e.g., connectively coupled to a bus, circuits, and so on of the appliances), electronic sensors can be embedded as part of the appliance to communicate with other devices about appliance usage (e.g., using short or long range communication technologies), sensors can be attached to the appliances using adhesives (e.g., the sensors can be included as part of stickers placed on the appliances), and so forth.

Other examples of objects can include clothes (e.g., pants, shirts, shorts, outerwear, undergarments, shoes, boots, and so on), sporting equipment (e.g., bats, balls, pads, helmets, sticks, skates, clubs, equipment bags, hunting and fishing equipment, camping equipment, optics, and so on), vehicles (e.g., cars, bicycles, motorcycles, aviation vehicles (planes, helicopters, and so on), watercraft, all-terrain vehicles, and so on), toys (e.g., dolls, action figures, blocks, remote control vehicles, miniaturized vehicles, games, and so on), consumable/disposable products (e.g., cleaning products, diapers, hygiene products, toilet paper, paper towels, napkins, and so on), and so forth. With regard to configuring or packaging such other items with sensors, they may be configured or packaged in a variety of ways. For example, sensors may be woven into the fabric or material of which clothes are made, the sensors can be included as part of the packaging in which the clothes are sold or in which the clothes are stored, the sensors can be included as part of clothing tags, and so forth. The sensors with which clothing is configured or packaged can communicate with devices about usage of the clothing (e.g., using short or long range communication technologies). With regard to sporting equipment, it may include embedded sensors such as gyroscopes, accelerometers, and the like, to detect usage and movement of the sporting equipment, such as ball flight or a movement path of a bat or club. Sporting equipment may also include other embedded sensors as part of the sporting equipment to communicate with devices about usage of the sporting equipment (e.g., using short or long range communication technologies). Vehicles can include a great many sensors for each part of a vehicle that is to be monitored. For example, seats of a vehicle can include sensors to determine when a person is sitting in the vehicle seat, engine components can include sensors to determine how those components are performing (e.g., that communicate data each time the component is under operation to indicate information associated with the operation, that test some components for levels of fluid, pressure, and so on), sensors to determine vehicle location, sensors to detect weather conditions, sensors to detect heat conditions, sensors to detect a level of darkness or lightness, and so forth. With regard to toys, the packaging of toys can include sensors to detect whether the packaging has been opened, electronic sensors can be embedded as part of the toys to communicate with devices about toy usage (e.g., using short or long range communication technologies), sensors can be attached to the toys using adhesives (e.g., the sensors can be included as part of stickers placed on the devices), and so forth. Consumable/disposable products can be configured or packaged with sensors in a similar manner, for instance, the packaging of consumable/disposable products can include sensors to detect whether the packaging has been opened, a remaining amount of the consumable/disposable product, whether the consumable/disposable product has surpassed a threshold condition causing it to no longer be safe for use, and so forth. Furthermore, the sensors with which consumable/disposable products are packaged and configured can communicate with devices about usage (e.g., using short or long range communication technologies). It is to be appreciated that the examples of objects and how these objects can be configured and/or packaged with a variety of different sensors should not be seen to limit the objects that can be configured or packaged with sensors or how those objects can be configured or packaged with sensors to enable them to interact as part of the IoT. Indeed, a variety goods not specifically enumerated herein can be objects of the IoT without departing from the spirit and scope of the techniques described herein.

The term “sensor” refers to any of a variety of types of sensors that objects can be configured with to detect usage events indicative of object use and produce data indicative of the object usage. Examples of sensors are enumerated in more detail in the discussion of the example environment. The term “usage event” refers to a change in the environment that results from use of an object and that is detectable by the sensors with which objects are configured. As mentioned above, an example usage event for a radiator of a car is a coolant level monitoring action. Usage events differ depending on an object as different objects are used in different ways, and different events are indicative of the objects being used. As used herein, the term “sensor data” refers to the data produced by the sensors of an object to describe the usage events detected for the object.

As used herein, “a digital medium environment” refers to the computing devices, the sensor configured objects, the connections among the computing devices and sensor configured objects, and the interfaces discussed in the example environment below and that make resources provided by service providers available to users.

In the following discussion, an example environment is first described that may employ the techniques described herein. Example implementation details and procedures are then described which may be performed in the example environment as well as other environments. Consequently, performance of the example procedures is not limited to the example environment and the example environment is not limited to performance of the example procedures.

Example Environment

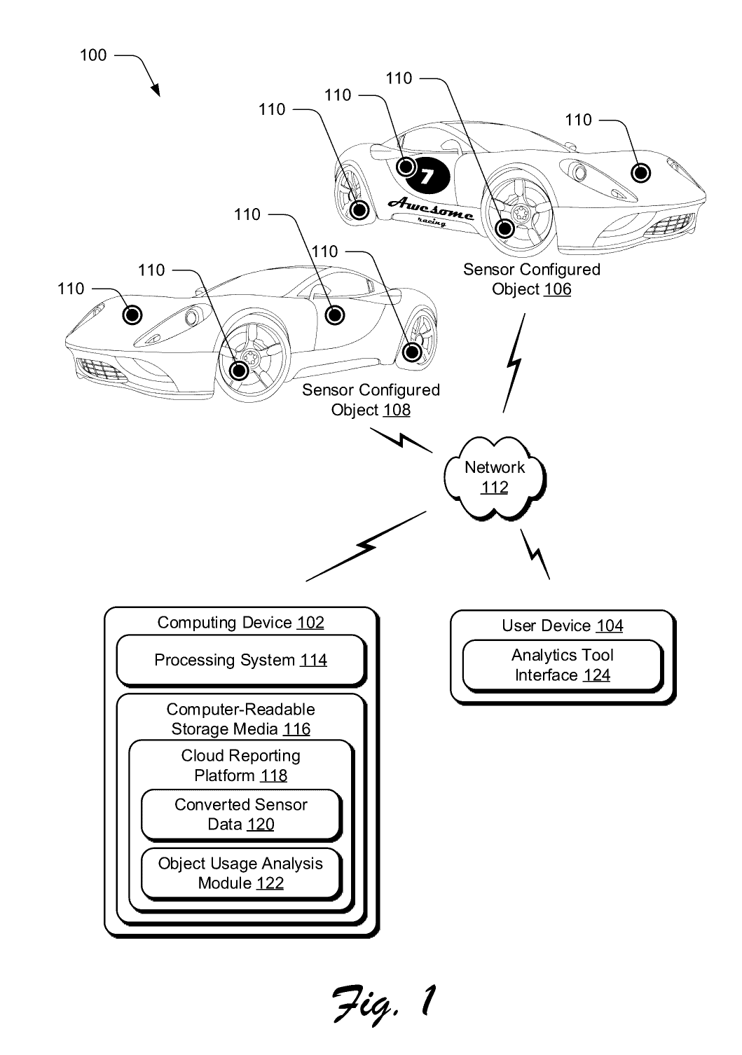

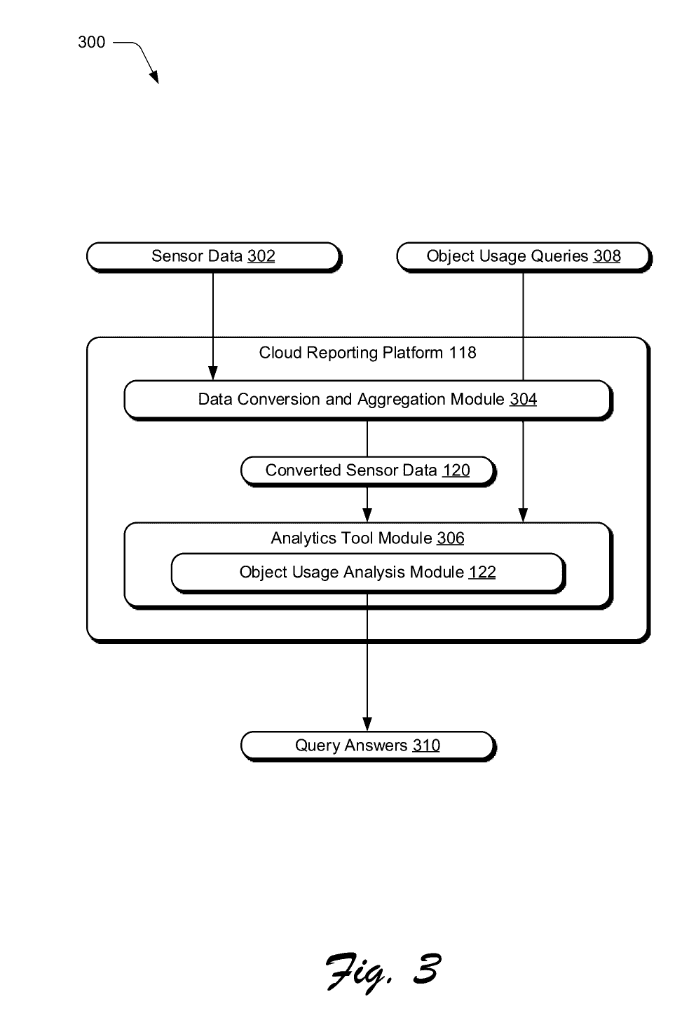

FIG. 1 is an illustration of a digital medium environment 100 in an example implementation that is operable to employ object usage analytics techniques described herein. The illustrated environment 100 includes a computing device 102 and a user device 104, which may be configured in a variety of ways. The illustrated environment 100 also includes objects that are part of the digital medium environment 100 through the inclusion of sensors that detect events indicative of object usage and produce data describing detected events. This data is then converted into aggregated data, which is maintained at a cloud reporting platform to answer queries regarding the object usage as further described in relation to FIG. 3.

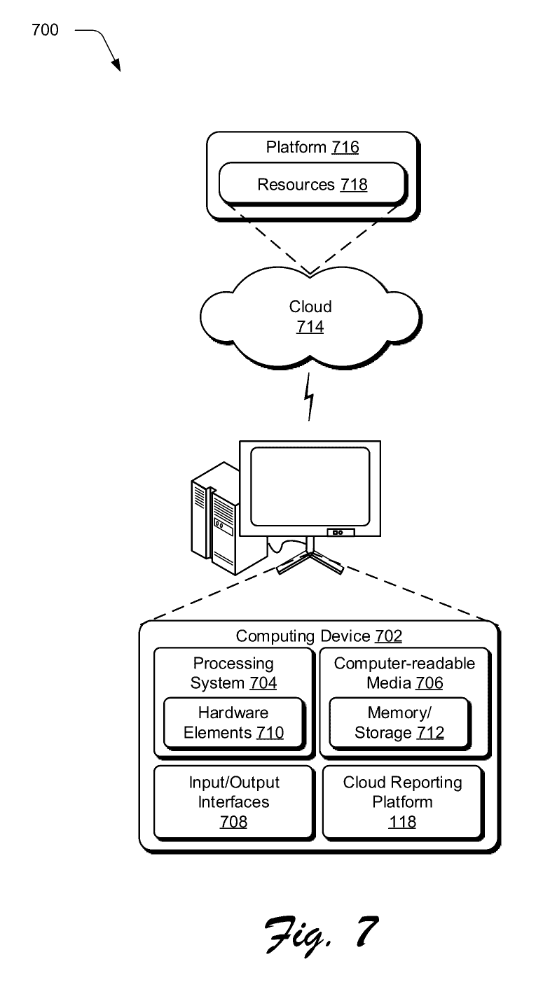

The computing device 102 and the user device 104, for instance, may each be configured as a desktop computer, a server computer, a laptop computer, a mobile device (e.g., assuming a handheld configuration such as a tablet or mobile phone), and so forth. Thus, the computing device 102 and the user device 104 may range from full resource devices with substantial memory and processor resources (e.g., service-provider computers, personal computers, game consoles) to low-resource devices with limited memory and/or processing resources (e.g., mobile devices). Additionally, although a single computing device 102 and a single user device 104 are shown, the computing device 102 and the user device 104 may each be representative of a plurality of different devices, such as multiple servers utilized by a business to perform operations “over the cloud” as further described in relation to FIG. 7.

The computing device 102 and the user device 104 are illustrated as included with a variety of objects within the digital medium environment 100 as part of the Internet-of-Things (IoT). The IoT describes a digital medium environment in which a plurality of objects are configured with sensors to detect events that occur as a result of using the objects and in which the sensors have connectivity (e.g., network functionality such as wired or wireless communication abilities) to communicate data for receipt by the computing device 102, or by other devices, such as a hub device. This allows communication of information to support aggregating and analyzing object usage data, thereby creating opportunities for integration between a physical environment in which objects are used and techniques to track and analyze object usage. This is used to support functionality to improve efficiency, accuracy, and aide marketers and manufacturers as well as users of the objects. In particular, this is used to efficiently aggregate sensor data and accurately make determinations of object usage from the aggregated sensor data.

Illustrated examples of objects included as part of this digital medium environment 100 include sensor configured objects 106, 108. For the convenience of discussion, the sensor configured objects illustrated relate to a single example scenario—an example automotive scenario—and two different cars. The example automotive scenario is but one scenario in which the techniques described herein can be used, however, and use of the example automotive scenario should not be seen to limit application of the invention. Indeed, the techniques described herein are capable of being applied to a variety of other scenarios in which object usage data can be provided by sensors of objects to describe object use. Regardless of the particular objects used or the scenario in which used, the objects are configured with sensors 110 to detect events that occur as a result of use and to ascertain information associated with the use.

The sensors 110 represent any of a variety of sensors that the objects may be configured with to detect events indicative of object use. By way of example, the sensors 110 can correspond to acoustic, sound, and vibration sensors; automotive and transportation sensors; chemical sensors; electric current, electric potential, magnetic, and radio sensors; flow and fluid velocity sensors; ionizing radiation and subatomic particle sensors; navigation instrument sensors; position, angle, displacement, distance, speed, and acceleration sensors; optical, light, imaging, and photon sensors; pressure sensors; force, density, and level sensors; thermal, heat, and temperature sensors; proximity and presence sensors; and so on. In other words, the sensors 110 with which objects of the IoT are configured enable events indicative of object use to be detected.

With regard to the objects in the automotive scenario, for instance, the sensors 110 can detect events indicative of use of various parts of the sensor configured objects 106, 108 (e.g., the two cars), such as braking by a driver or automatic braking by a braking system, monitoring a coolant level of the radiator, pushing coolant from the radiator, starting the cars, turning off the cars, turning on lights, and so on. Further, the sensors 110 of the sensor configured objects 106, 108 may enable a determination of location at a given time, weather conditions, and so forth.

Once the sensors 110 detect an event indicative of an object's use, the sensors 110 produce data describing the detected event. For example, each of the sensors 110 can produce a data packet in response to detecting an event for which the sensor is employed. The data packets produced by the sensors 110 can be formatted in a structured fashion, which can include a variety of predetermined fields that are populated according to the detected event. Example data packets that can be produced by the sensors 110 of the sensor configured objects 106, 108 are described in more detail herein below.

Once produced, the sensor data can be communicated over a network 112, such as the Internet, to provide a “cloud-based” computing environment, in which the computing device 102 provides services of one or more service providers. In one or more implementations, at least some of the sensors 110 of the sensor configured objects 106, 108 may be configured to communicate the sensor data over the network 112 directly to the computing device 102. In addition or alternately, some of the sensors 110 of the sensor configured objects 106, 108 may first communicate the sensor data to a hub device (e.g., a navigation system or mobile communications system of the sensor configured objects 106, 108, a mobile phone of an owner of the sensor configured objects 106, 108, and so on), which then routes the sensor data to the computing device 102.

Service providers are generally configured to make various resources available over the network 112 to users. In some scenarios, users sign up for accounts that are employed to access corresponding resources from a provider. The provider authenticates credentials of a user (e.g., username and password) before granting access to an account and corresponding resources. Other resources are made freely available, (e.g., without authentication or account-based access). The resources can include any suitable combination of services and/or content typically made available over a network by one or more providers. Some examples of services include, but are not limited to, analytics services (e.g., Adobe® Analytics), which can be used to collect, organize, and report data describing object usage, communication services (e.g., email, instant messaging, voice over Internet Protocol (VoIP), and the like), and so forth.

Broadly speaking, the computing device 102 represents functionality of a service provider to obtain sensor data that describes object usage, efficiently aggregate the sensor data, and accurately make a determination of object usage from the aggregated sensor data to answer queries made regarding the object usage. The computing device 102 has a processing system 114 that includes one or more processing devices (e.g., processors) and one or more computer-readable storage media 116. The illustrated digital medium environment 100 also includes cloud reporting platform 118 that has converted sensor data 120 and an object usage analysis module 122 embodied on the computer-readable storage media 116 and operable via the processing system 114 to implement corresponding functionality described herein.

The cloud reporting platform 118 represents functionality to implement techniques for object usage analytics as described herein. In particular, the cloud reporting platform 118 represents functionality to obtain sensor data for objects of the IoT, such as sensor data for the sensor configured objects 106, 108, and which describes usage events detected by the sensors 110 of the sensor configured objects 106, 108. In addition, the cloud reporting platform 118 represents functionality to efficiently aggregate the sensor data and to maintain this sensor data. To do so, the cloud reporting platform 118 converts the data packets received from the sensors 110 into the converted sensor data 120 for aggregation. For example, the cloud reporting platform 118 converts the data packets into dimensions and metrics, which are maintained by the cloud reporting platform 118 as the converted sensor data 120. The cloud reporting platform 118 aggregates the converted sensor data 120 for an object with other aggregated usage data of the object as well as with aggregated usage data of other objects of the IoT, e.g., other objects that relate to the object through inclusion as part of a “parent” system. An example of a “parent system” is a car that includes multiple sensors which detect different usage events (e.g., braking events, radiator events, entertainment console events, driver environment adjustment events and so on) that result from use of different parts of the car but that each relate to use of the car.

The cloud reporting platform 118 also represents functionality to expose a variety of analytics tools via which users can make queries regarding object usage. The cloud reporting platform 118, for instance, exposes analytics tools which enable the user device 104 to provide a user with an analytics tool interface 124. The analytics tool interface 124 represents functionality to provide a user access to the converted sensor data 120. For example, the analytics tool interface 124 allows a user to select a particular analytics tool and, via the selected analytics tool, request information about object usage from the cloud reporting platform 118. By way of example and not limitation, the analytics tool interface 124 may allow a user to access the converted sensor data 120 using a freeform query and segmentation tool, a path and sequencing tool, an anomaly detection tool, a contribution analysis tool, a cohort analysis tool, and so forth. The analytics tool a user uses to request information about object usage formats such requests as queries for information about usage of an object.

In addition to converting sensor data and maintaining aggregated usage data as the converted sensor data 120, the cloud reporting platform 118 also represents functionality to answer queries for information regarding object usage. To do so, the cloud reporting platform 118 employs the object usage analysis module 122. The object usage analysis module 122 represents functionality to process the converted sensor data 120 to derive information that describes use of objects in the IoT. With access to the converted sensor data 120 aggregated for many objects, the object usage analysis module 122 can make an accurate determination of object usage.

With reference to the continuing example, the object usage analysis module 122 is capable of computing an amount the sensor configured objects 106, 108 are used, for example. Regarding brakes of the sensor configured objects 106, 108, for instance, the object usage analysis module 122 can compute a number of miles over which the brakes have been used, an amount of time that the brakes have been engaged, a number of times a braking system has automatically engaged the brakes, an average stopping distance at a certain speed and a certain pressure with which the brakes are engaged, and so on.

Once the object usage analysis module 122 derives the requested information about object usage from the converted sensor data 120, that information can be configured for communication for receipt by a user. The information derived by the object usage analysis module 122 enables the queries made using the analytics tools to be answered. One way in which a query may be answered is with a report that indicates the information regarding the object usage. Regardless of the format of the information (e.g., report, graph(s), etc.), the cloud reporting platform 118 generates answers to queries received from the analytics tools. The cloud reporting platform 118 then communicates these answers to the users requesting the object usage information. For instance, the cloud reporting platform 118 communicates generated answers over the network 112 for receipt by the user device 104, which displays the generated answer to a user via the analytics tool interface 124.

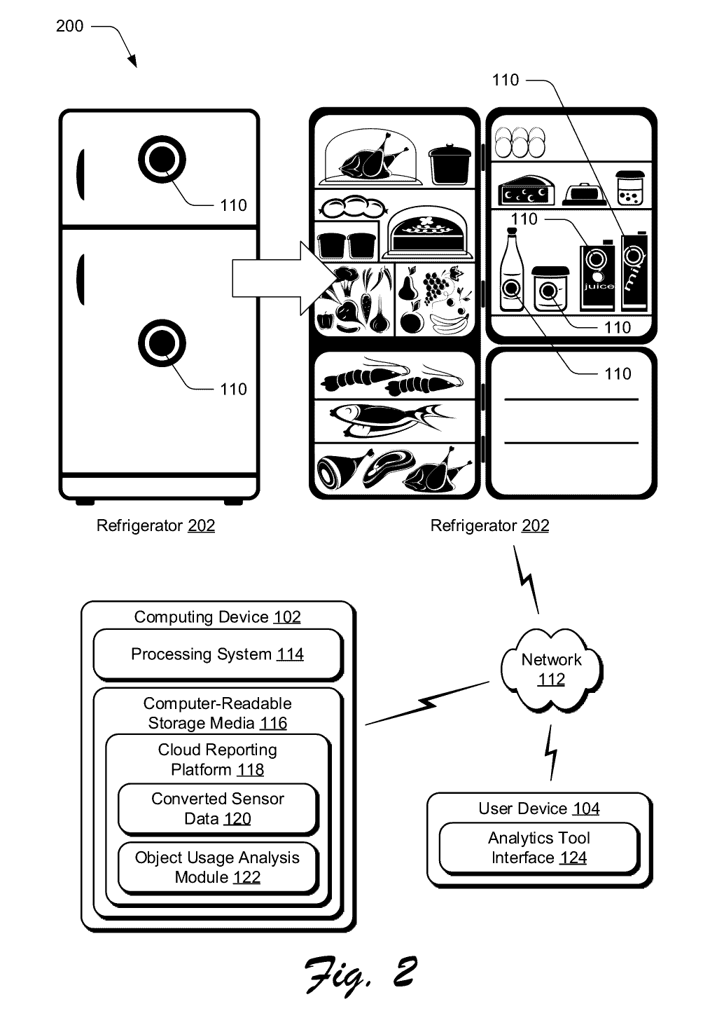

FIG. 2 is an illustration of the digital medium environment in another example implementation at 200 that employs object usage analytics techniques. In particular, the example illustrated at 200 illustrates another example scenario—a home appliance scenario—that includes refrigerator 202, which is illustrated as being closed at left, and open at right exposing food stored in the refrigerator. FIG. 2 also depicts that the refrigerator 202 includes the sensors 110 and that the food stored in the refrigerator 202 includes or is also packaged with the sensors 110. The refrigerator 202 can be configured with sensors to detect a variety of information about object usage, such as a temperature (or temperature distribution) of a refrigeration portion of the refrigerator 202, a temperature (or temperature distribution) of a freezer portion of the refrigerator 202, weight of food items in the refrigerator, whether and which items are taken out of the refrigerator 202 and put in the refrigerator, smells that result from food spoilage, and so forth. The food in the refrigerator 202 can also be configured or packaged with the sensors 110, as described in more detail above, to detect information about the food, e.g., whether the food is still edible, a remaining time until the food is no longer edible, a remaining amount of the food, and so forth.

As with the example automotive scenario, the sensors 110 in the example home appliance scenario detect events indicative of an object's use (e.g., the refrigerator 202 or the food stored therein), produce data packets that describe the detected event (e.g., a food item was removed from the refrigerator 202), and communicate the data packets over the network 112 to the computing device 102. The cloud reporting platform 118 can then convert the data packets into dimensions and metrics, which are maintained by the cloud reporting platform 118 as the converted sensor data 120. The cloud reporting platform aggregates the converted sensor data 120 for the refrigerator 202 with other aggregated usage data of the refrigerator 202 as well as with aggregated usage data of other objects of the IoT, e.g., the food in the refrigerator 202. The analytics tools of the cloud reporting platform 118 can then be used to provide information about usage of the refrigerator 202 and the food therein to a user of the user device 104.

In one or more implementations, the cloud reporting platform 118 and the object usage analysis module 122 are implementable as software modules, hardware devices, or using a combination of software, hardware, firmware, fixed logic circuitry, etc. Further, the cloud reporting platform 118 and the object usage analysis module 122 can be implementable as standalone components of the computing device 102 as illustrated. In addition or alternatively, cloud reporting platform 118 and the object usage analysis module 122 can be configured as components of a web service, an application, an operating system of the computing device 102, a plug-in module, or other device application as further described in relation to FIG. 7.

Having considered an example environment, consider now a discussion of some example details of the techniques for object usage analytics in accordance with one or more implementations.

Object Usage Analytics

This section describes some example details of techniques for object usage analytics in accordance with one or more implementations. FIG. 3 depicts a system in the digital environment of FIGS. 1 and 2 for efficiently aggregating sensor data and accurately making determinations of object usage from the aggregated sensor data to answer queries regarding object usage that are made by users via analytics tools of a cloud reporting platform.

The example system 300 includes sensor data 302, which is provided as input to the cloud reporting platform 118. The sensor data 302 represents data packets which describe events that result from use of sensor configured objects 106, 108, and are detected by the sensors 110 included in those objects. The sensor data 302 for a particular object (or part of an object) may be configured according to a data structure that is predefined according to how the particular object (or part) is used. For example, the sensor data 302 for a particular object can include data fields that are different than those used in conjunction with another object, and can be chosen to describe the events which occur as a result of using the particular object.

The following are examples of the sensor data 302 that different sensors of the sensor configured objects 106, 108 in the example automotive scenario can produce based on detection of a usage event:

{

action: “startup”,
object: “timing belt”,
parent: “Sports Car”,
status: 6

{
{

action: “spray fuel”,
object: “fuel injector”,
parent: “Sports Car”,
quantity: 3.3
airPressure: 13.2
airHumidity: 3.4

{
{

action: “monitor coolant level”,
object: “radiator”,
parent: “Sports Car”,
quantity: 65.7

{
{

action: “push coolant from radiator”,
object: “water pump”,
associatedObject: “radiator”,
parent: “Sports Car”,
quantity: 1.29

{

In another scenario in which the sensors 110 are included as part of a pair of shoes and produce sensor data 302 that describes usage of the pair of shoes, the sensor data 302 can be formatted as follows:

{

action: “step”,
location: “−40.5345, 34.2451”,
pressure: “38.2”,

{

As is indicated by these examples, the data packets produced as a result of detecting object usage events can have a variety of fields that the sensors 110 populate with values to indicate different information depending on the object and the field, such as a name of a usage event, a parent system, associated objects, a location, an associated time, other values associated with the usage events, and so on. Despite differences in the sensor data 302 that is produced for different objects, the sensor data 302 is capable of describing use of the objects of the IoT.

Once produced, the sensors 110 send the information to the cloud reporting platform 118. As discussed above, the sensors 110 may send the information directly to the cloud reporting platform 118, e.g., over the Internet. Some of the sensors 110, however, may not be capable of sending the sensor data 302 directly over the network 112 to the cloud reporting platform 118. Sensors that are not capable of sending the sensor data 302 directly to the cloud reporting platform 118 over a network may instead send the sensor data 302 first to a hub device, e.g., using some short range communication technology such as Bluetooth®. The hub device can then send the sensor data 302 over the network 112 to the cloud reporting platform 118. In any case, the sensor data 302 is obtained by the cloud reporting platform 118.

In the illustrated example, the cloud reporting platform 118 includes data conversion and aggregation module 304 (“DC&A module 304”). The DC&A module 304 represents functionality of the cloud reporting platform 118 to convert the obtained sensor data 302 into the converted sensor data 120, which can be maintained at the cloud reporting platform 118, such as in databases capable of maintaining aggregated data for vast numbers of objects of the IoT. By way of example, the DC&A module 304 converts the individual data packets that make up the sensor data 302 into dimensions and metrics. This information is then maintained as the converted sensor data 120 in storage associated with the cloud reporting platform 118. By aggregating the sensor data 302 at a centralized location, e.g., the cloud reporting platform 118, the DC&A module 304 can aggregate the sensor data 302 efficiently.

The DC&A module 304 aggregates the converted sensor data 120 for an object with other usage data of the object. In this way, accurate determinations about usage of a single object can be made from the converted sensor data 120, e.g., usage of a part of the sensor configured object 106. The DC&A module 304 also aggregates the converted sensor data 120 for an object with the usage data of other objects. This allows accurate determinations about object usage to be made for a parent system or for multiple different objects. For example, this allows accurate determinations to be made about usage events of the sensor configured object 106 (e.g., a sports car), such as what parts of the sensor configured object 106 may have contributed to an object failure. The aggregation also allows data about multiple objects (e.g., sensor configured object 106 and sensor configured object 108) to be analyzed.

Broadly speaking, aggregation of the sensor data 302 can involve batching the sensor data 302 that comes from a single sensor as well as from multiple sensors before the sensor data 302 is received at the cloud reporting platform 118. Aggregation of the sensor data 302 can also involve aggregating the sensor data 302 for each of the sensors 114 of an object to obtain counts and averages related to usage of the object. In other words, the aggregating enables an individual's use of an object to be measured or analytics for the object to be obtained based on the data from each sensor of the object. Further, the aggregating can involve aggregating the sensor data 302 from a sensor of an object with the sensor data 302 from the same sensors on other objects. This enables the cloud reporting platform 118 to measure how each user uses a particular model of an object, or a particular part of the particular model of the object. Further still, the aggregating can involve aggregating the sensor data 302 from the multiple sensors of an object or the sensor data 302 from multiple objects into a single data set.

For analysis of the converted sensor data 120, the cloud reporting platform 118 exposes a variety of analytics tools. Analytics tool module 306 represents functionality of the cloud reporting platform 118 to expose these analytics tools. For example, the analytics tool module 306 can provide the analytics tool interface 124 to the user device 104 so that a user of the user device 104 can examine, play with, or perform statistical computations on the converted sensor data 120. The analytics tool module 306 may, for instance, expose the analytics tools as part of a web-based application. By way of example, a user of the user device 104 may install the web-based application on the user device 104 to serve as the analytics tool interface 124. To view information regarding object usage, the user in this scenario launches the web-based application, selects an analytics tool, and then indicates via the selected analytics tool the particular information in which the user is interested. In one or more embodiments, the analytics tool interface 124 is delivered as part of a web page that a user can access at the user device 104 using a browser application.

The analytics tool module 306 can expose users to a variety of analytics tools through the analytics tool interface 124. Regardless of how the analytics tool interface 124 is implemented, once the user selects an analytics tool, the user can make queries via the selected analytics tool to request a variety of information regarding object usage. Object usage queries 308 represent the queries made by users via the exposed analytics tools. The object usage queries 308 can request a variety of information in different formats from the cloud reporting platform 118 depending, in part, on the analytics tool a user is using. The analytics tools exposed by the analytics tool module 306 can include several different tools, including freeform query and segmentation tools, path and sequencing tools, anomaly detection tools, contribution analysis tools, cohort analysis tools, and so on. It should be appreciated that the cloud reporting platform 118 can expose analytics tools for analyzing aggregated usage data in addition to or different from the enumerated analysis tools without departing from the spirit or scope of the techniques described herein.

Freeform query and segmentation tools enable a user to compose freeform queries to request information about object usage and to segment the converted sensor data 120 into different defined segments. To the extent that the converted sensor data 120 represents aggregated information from sensors 110 of objects across the IoT, the freeform query and segmentation tools enable a user to query this data in aggregate. Assume that in the example automotive scenario, the sensor configured objects 106, 108 are a same sports car manufactured by a particular manufacturer but owned by different people and generally driven in different locations. Assume also that several more of these sports cars are driven and that the sensor data 302 collected for these other sports cars is aggregated and maintained at the cloud reporting platform 118, e.g., as the converted sensor data 120. Assume also that some of these sports cars are generally driven in a warm climate while others are driven in a cold climate. Given the freeform query and segmentation tool, the manufacturer of the sports car can request via the tool information to compare how much the sports car is driven in warm climates in comparison to cold climates. In other words, the freeform query and segmentation tool gives the sports car manufacturer the ability to perform freeform queries on the aggregate population of their sports cars that are connected to the IoT. The information requested through the query can then be provided to the user, e.g., via the analytics tool interface 124.

Path and sequencing tools enable a user to determine a sequence of actions that are commonly performed when using objects of the IoT. The sequencing of common actions can be useful in an analysis to see how users actually use products (or system components) once the products are purchased. Consider an example fishing scenario in which a fishing rod is used. A manufacturer of the fishing rod may hypothesize that the sequence of events usually performed with the fishing rod is to perform a cast, wait, and then reel in. Given the converted sensor data 120 that is aggregated for each instance of the fishing rod sold and connected to the IoT, the path and sequencing tools may find that a most common sequence of events for the fishing rod (across the aggregated data) it to perform a cast, reel in, perform a recast (e.g., because it is difficult to make an accurate cast the first time), wait, and reel in. Thus, the path and sequencing tools can be used to compare a suspected manner in which a manufacturer's products are used to an actual manner in which the manufacturer's products are used. An indication of a use path or sequence of object usage can then be presented to a user, e.g., via the analytics tool interface 124.

Anomaly detection tools enable a user to perform statistical modeling and automatically uncover anomalies in the converted sensor data 120. Returning to the example automotive scenario, assume for instance that 96% of the 2016 version of the sports car that is manufactured by its manufacturer had a water pump malfunction in the last day. The anomaly detection tools can uncover such anomalies by processing the converted sensor data 120. The anomaly detection tools can then present an indication of such anomalies to a user, e.g., via the analytics tool interface 124.

Contribution analysis tools enable a user to uncover usage events that lead to other events, e.g., events that lead to object failures. With reference to anomaly detection, the contribution analysis tools enable a user to analyze potential contributing factors that actually contributed to a given event or failure. Continuing with the water pump malfunction example, a contribution analysis tool may reveal that in most of the sports cars having this malfunction, the radiator of the sports car lost coolant slowly over time. This information is known because the sensors 110 with which the radiators are configured monitor the coolant level across each of the manufacturer's sports cars connected to the IoT. Given this information, the manufacturer can then examine the factors that contribute to the problem rather than simply the resulting issue. In any case, an indication of factors that contribute to a given event can be presented to a user, e.g., via the analytics tool interface 124.

Cohort analysis tools enable a user to identify engagement patterns with an object by examining cohorts of object users. People who purchase an object at a same time are considered part of a same “cohort,” for example. By collecting data about object usage through the IoT, behaviors of people in a same cohort can be analyzed and usage patterns revealed. Assume, for example, that an analysis is performed with a cohort analysis tool of people who purchased paintball guns during different months throughout a year. The cohort analysis tool can reveal a trend that typically three months after purchase of a paintball gun, the paintball gun is shot less than it was initially shot. By way of example, the cohort analysis tool can reveal that the amount paintball guns are shot three months after purchase is twenty percent less than the amount the paintball guns were initially shot. An indication of trends revealed among a cohort by performing a cohort analysis can be presented to the user, e.g., via the analytics tool interface 124.

In addition to these tools, the analytics tool interface 124 can enable a user to make an object usage query 308 to request raw unaggregated data, e.g., the sensor data 302. By way of example, the analytics tool interface 124 can allow a user to query for the sensor data 302 produced by a particular sensor of an object, the sensor data 302 produced by each sensor of a particular object, the sensor data 302 produced by multiple of the same object, and so on.

Accordingly, the object usage queries 308 made by users via the analytics tools, along with the converted sensor data 120, serve as input to the analytics tool module 306. Once a query is received via an analytics tool, the analytics tool module 306 is capable of employing the object usage analysis module 122 to make a determination of object usage. As discussed above, the object usage analysis module 122 is capable of performing an analysis corresponding to the query and deriving information regarding object usage from the converted sensor data 120. The analytics tool module 306 then uses the results of the analysis, e.g., the information derived regarding the object usage, to answer the object usage queries 308. In other words, the analytics tool module 306 uses the analyses performed and information derived by the object usage analysis module 122 to generate query answers 310. A format of a query answer 310 can depend largely on the analytics tool via which a corresponding object usage query 308 was made. For instance, a query answer 310 generated for an object usage query 308 made via an anomaly detection tool can be formatted differently from one generated for an object usage query 308 made via a cohort analysis tool.

In any case, the query answers 310 are generated to present the requested information that describes the usage of the object. In particular, the query answers 310 are generated to present the requested information via the analytics tool that was used to make the query. Once generated, the query answers 310 are communicated for receipt by the user. By way of example, the query answers 310 are communicated over the network 112 to the user device 104 where the query answers 310 are presented through the analytics tool interface 124.

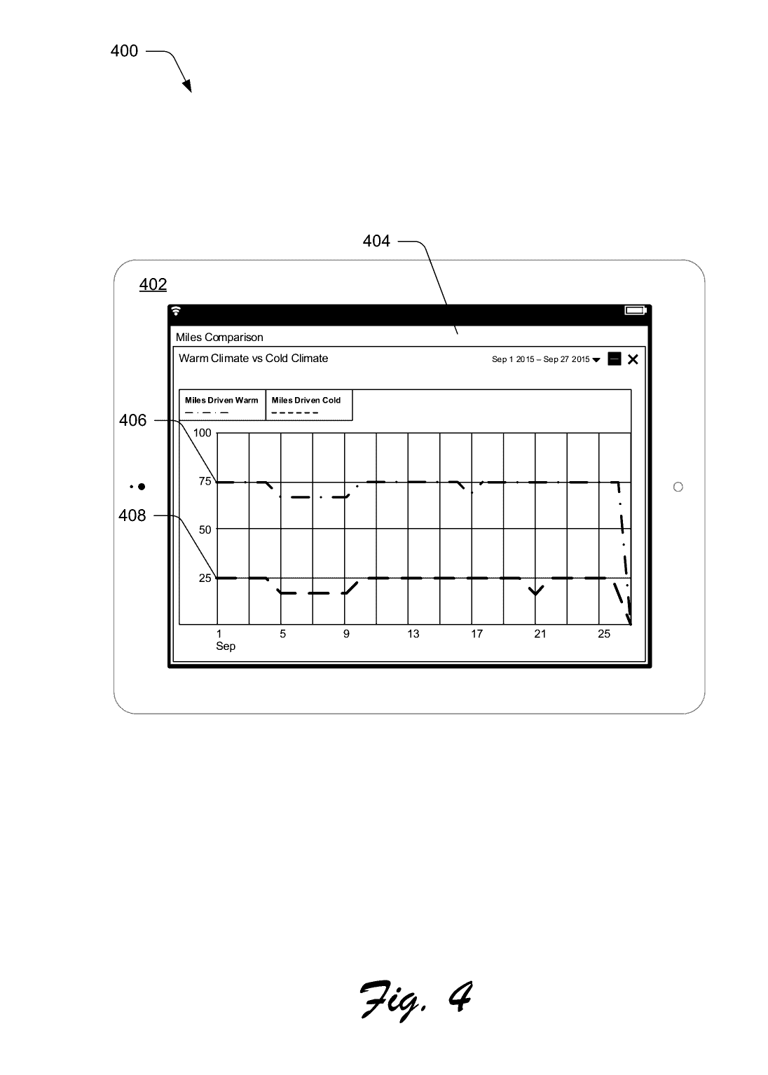

With regard to the presentation of the query answers 310 via the analytics tool interface 124, consider FIG. 4. FIG. 4 depicts an example at 400 of a user interface that is generated according to a query answer to present information that describes object usage to a user via an analytics tool. In particular, FIG. 4 includes a user computing device 402, which is depicted displaying a user interface 404. In this example, the user interface 404 presents a comparison (configured as a line graph) of miles driven in a warm climate against miles driven in a cold climate. A query answer 310 indicative of this comparison may be generated in response to a situation, as discussed above in reference to the freeform query tool, in which the manufacturer of the sensor configured objects 106, 108 (the sports cars) requests information via the freeform and segmentation tool about an amount that the sports car is driven in warm climates in comparison to cold climates. The user interface includes line 406, which is indicative of an average number of miles driven on a daily basis per car with the sports car in warm climates, and line 408, which is indicative of an average number of miles driven on a daily basis per car with the sports car in cold climates. The user interface 404 depicted in FIG. 4 and the format in which the requested object usage information is presented is but one example of the information that can be presented to a user regarding object usage and the format in which the information can be presented. The analytics tools can be employed to present users with a wide variety of information regarding the usage of objects in the IoT and this information can be formatted in a variety of ways without departing from the spirit or scope of the techniques described herein.

Having discussed example details of the techniques for object usage analytics, consider now some example procedures to illustrate additional aspects of the techniques.

Example Procedures

This section describes example procedures for object usage analytics in one or more implementations. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks. In at least some implementations the procedures are performed by a suitably configured device, such as the example computing device 102 of FIG. 1 or one implemented as the example system 300 of FIG. 3 that make use of a cloud reporting platform 118, converted sensor data 120, and an object usage analysis module 122.

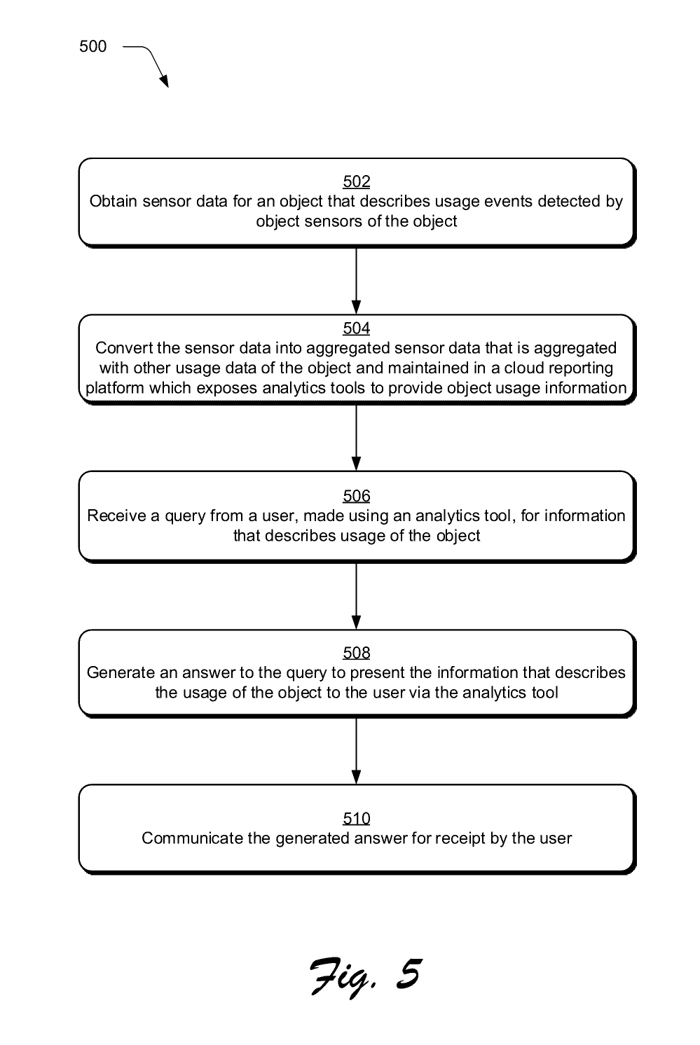

FIG. 5 depicts an example procedure 500 in which sensor data obtained for an object is aggregated and maintained in a cloud reporting platform, and in which a query made for information about the object via an analytics tool of the cloud reporting platform is answered. The example procedure 500 is implemented in a digital medium environment (e.g., the Internet of Thing (IoT)) in which sensors are included as part of objects, detect usage events that result from object usage, and produce sensor data indicative of the events. To answer queries regarding object usage that are made by users via analytics tools of a cloud reporting platform, sensor data is obtained for an object that describes a usage event detected by object sensors of the object (block 502). For example, the cloud reporting platform 118 obtains the sensor data 302 that is produced by the sensors 110 of the sensor configured objects 106, 108. The sensor data 302 describes a usage events detected by the sensors 110 that occurs as a result of use of the sensor configured objects 106, 108 (or a monitored part of those objects).

The obtained sensor data is converted into aggregated usage data that is aggregated with other usage data of the object and maintained in the cloud reporting platform (block 504). The cloud reporting platform at which the aggregated usage data is maintained exposes analytics tools to provide users with information that describes the object usage. For example, the DC&A module 304 converts the sensor data 302 obtained by the cloud reporting platform 118 into aggregated usage data, which is represented by the converted sensor data 120. The converted sensor data 120 is aggregated with other usage data of the sensor configured objects 106, 108 and is maintained at the cloud reporting platform 118. The analytics tool module 306 of the cloud reporting platform 118 exposes analytics tools to users to provide them with information that describes object usage. For example, the analytics tool module 306 provides information to the user device 104 so that the analytics tool interface 124 can be output at the user device 104.

A query for information that describes usage of the object and made using an analytics tool is received (block 506). For example, a query made by a user of the user device 104 using the analytics tool interface 124 for information regarding usage of the sensor configured objects 106, 108 is received at the cloud reporting platform 118. The query is then processed by the analytics tool module 306. For example, the analytics tool module 306 employs the object usage analysis module 122 to accurately make a determination of object usage from the converted sensor data 120 to answer the query regarding object usage.

An answer to the query is generated to present the information that describes the usage of the object to the user via the analytics tool (block 508). For example, the analytics tool module 306 takes the information derived by the object usage analysis module 122 and generates an answer to the query received at block 506. The analytics tool module 306 generates the answer for presentation to a user via the analytics tool used to make the query, e.g., via the analytics tool interface 124. The answer can be configured in a variety of formats, such as a graph, a report, a portion of text, and so on.

Once generated, the answer is communicated for receipt by the user (block 510). For example, the cloud reporting platform 118 communicates the answer generated at block 508 over the network 112 to the user device 104, where the answer can be output to a user via the analytics tool interface 124.

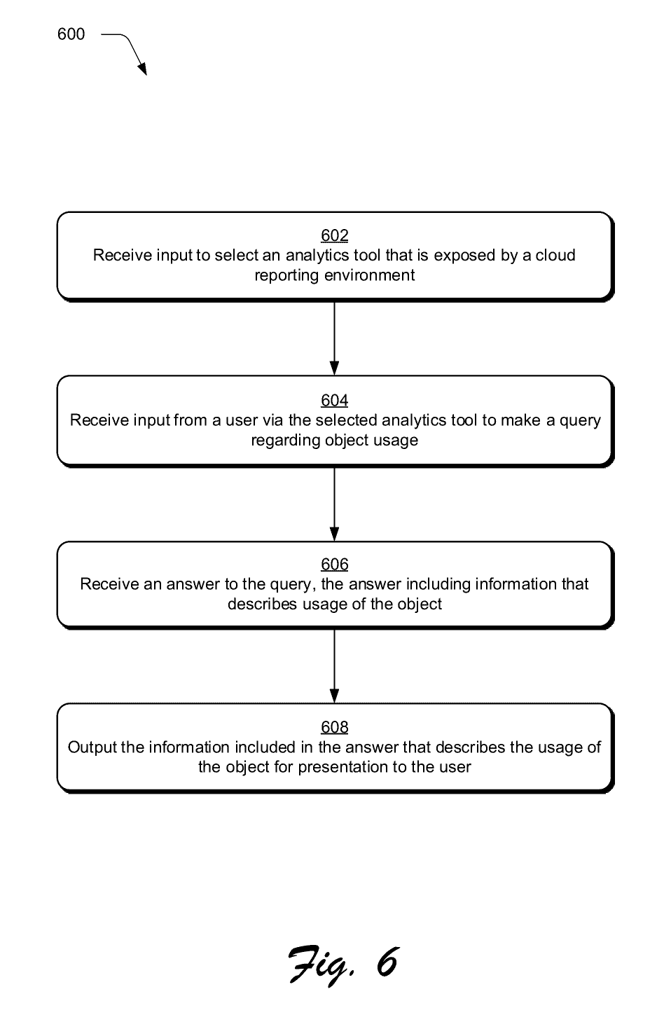

FIG. 6 depicts an example procedure 600 in which a selected analytics tool of a cloud reporting platform is used to make a query for information regarding object usage and in which an answer regarding the object usage is received and output. Like the example procedure 500, the example procedure 600 is also implemented in a digital media environment such as the IoT. A tool selection input is received to select an analytics tool exposed by a cloud reporting platform (block 602). For example, input is received at the user device 104 via the analytics tool interface 124 to select one of the analytics tools that is exposed by the cloud reporting platform 118 to provide information regarding usage of objects of the IoT.

A query regarding object usage is made by a user via the selected analytics tool (block 604). For example, a query regarding usage of the sensor configured objects 106, 108 is made via the analytics tool interface 124. In so doing, a user of the user device 104 requests certain information via an analytics tool. The request is formatted as an object usage query 308, which is communicated over the network 112 for receipt by the cloud reporting platform 118. As described above in reference to FIG. 5, the cloud reporting platform 118 employs functionality to generate query answers 310 and communicates the answers over the network 112 to the user device 104 for presentation.

An answer to the query is received which includes information that describes usage of the object (block 606). For example, the user device 104 receives a query answer 310 that includes the information requested by the query that was made at block 604. In particular, the information included in the answer describes usage of the sensor configured objects 106, 108.

The information included in the answer that describes the usage of the object is output for presentation to the user (block 608). For example, the information included in the query answer 310 is output via the analytics tool interface 124 at the user device 104. With reference to FIG. 4, the user interface 404 is displayed on the computing device 402, which conveys information describing usage of the sensor configured objects 106, 108.

Having described example procedures in accordance with one or more implementations, consider now an example system and device that can be utilized to implement the various techniques described herein.

Example System and Device

FIG. 7 illustrates an example system generally at 700 that includes an example computing device 702 that is representative of one or more computing systems and/or devices that implement the various techniques described herein. This is illustrated through inclusion of the cloud reporting platform 118, which operates as described above. The computing device 702 may be, for example, a server of a service provider, a device associated with a client (e.g., a client device), an on-chip system, and/or any other suitable computing device or computing system.

The example computing device 702 includes a processing system 704, one or more computer-readable media 706, and one or more I/O interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This includes implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media does not include signals per se or signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information for access by a computer.

“Computer-readable signal media” refers to a signal-bearing medium that is configured to transmit instructions to the hardware of the computing device 702, such as via a network. Signal media typically embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that is employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules are implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software are achieved at least partially in hardware, e.g., through use of computer-readable storage media and/or hardware elements 710 of the processing system 704. The instructions and/or functions are executable/operable by one or more articles of manufacture (for example, one or more computing devices 702 and/or processing systems 704) to implement techniques, modules, and examples described herein.

The techniques described herein are supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 abstracts resources and functions to connect the computing device 702 with other computing devices. The platform 716 also serves to abstract scaling of resources to provide a corresponding level of scale to encountered demand for the resources 718 that are implemented via the platform 716. Accordingly, in an interconnected device implementation, implementation of functionality described herein is distributed throughout the system 700. For example, the functionality is implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment in which sensors are included as part of objects, detect usage events that result from object usage, and produce sensor data indicative of the usage events, a method implemented by one or more computing devices to efficiently aggregate the sensor data and accurately make a determination of object usage from the aggregated sensor data to provide information regarding the object usage via analytics tools of a cloud reporting platform, the method comprising:
obtaining the sensor data for an object by the one or more computing devices that describes a usage event detected by one or more object sensors of the object;
converting the sensor data into aggregated usage data by the one or more computing devices that is aggregated with other usage data of the object and maintained in the cloud reporting platform which exposes the analytics tools to provide users with information that describes the object usage;
generating, by the one or more computing devices, information that describes usage of the object for presentation via an analytics tool; and
communicating the generated information by the one or more computing devices for receipt by a user that requested the information via the analytics tool.

2. A method as described in claim 1, further comprising aggregating the usage data with the other usage data of the object and with usage data of other objects.

3. A method as described in claim 1, further comprising exposing the analytics tools of the cloud reporting platform, the exposed analytics tools being accessible over a network to user devices to enable the user devices to present an analytics tools interface which enables users to make queries of the aggregated usage data maintained in the cloud reporting platform.

4. A method as described in claim 1, wherein the analytics tools include at least one tool that allows freeform queries to be made of the aggregated usage data maintained in the cloud reporting platform.

5. A method as described in claim 1, wherein the analytics tools include at least one tool that allows queries to be made that request one or more segments of the aggregated usage data maintained in the cloud reporting platform.

6. A method as described in claim 1, wherein the analytics tools include at least one tool that allows queries to be made of the aggregated usage data maintained in the cloud reporting platform that request a common sequence of the usage events for the object.

7. A method as described in claim 1, wherein the analytics tools include at least one tool that allows queries to be made to detect anomalies in the aggregated usage data that is maintained for the object in the cloud reporting platform.

8. A method as described in claim 1, wherein generating the information that describes the usage of the object includes determining the usage of the object from the aggregated usage data maintained in the cloud reporting platform.

9. A method as described in claim 1, wherein the generated information enables a user device to display the information that describes the usage of the object via the analytics tool.

10. A method as described in claim 1, wherein the generated information enables a user device to display the information that describes the usage of the object via the analytics tool as at least one of a report or a graph.

11. A method as described in claim 1, wherein the obtained sensor data is formatted in data packets which each describe a particular usage event.

12. A method as described in claim 1, wherein the sensor data obtained for the object has different fields for describing the usage events of the object than the sensor data obtained for different objects.

13. In a digital medium environment in which sensors are included as part of objects, detect usage events that result from object usage, and produce sensor data indicative of the usage events, a method implemented by one or more computing devices to provide information regarding object usage via analytics tools of a cloud reporting platform which efficiently aggregates the sensor data and accurately makes a determination of the object usage from the aggregated sensor data, the method comprising:
receiving a tool selection input by the one or more computing devices to select an analytics tool that is exposed by the cloud reporting platform to provide users with information that describes the object usage;
communicating, by the one or more computing devices, a request made via the selected analytics tool for information that describes usage of an object to the cloud reporting platform for processing, the information that describes usage of the object determined from sensor data that is converted into aggregated usage data, aggregated with other usage data of the object, and maintained by the cloud reporting platform;
receiving, by the one or more computing devices, the information that describes the usage of the object from the cloud reporting platform; and
outputting, via the selected analytics tool and by the one or more computing devices, the information that describes the usage of the object.

14. A method as described in claim 13, further comprising:
receiving an additional tool selection input to select a different analytics tool exposed by the cloud reporting platform;
receiving an additional request via the different analytics tool for different information that describes usage of the object;
communicating the additional request to the cloud reporting platform for processing;
receiving the different information that describes the usage of the object from the cloud reporting platform; and
outputting via the different analytics tool the different information that describes the usage of the object.

15. A method as described in claim 14, wherein the information requested via the analytics tool and the different information requested via the different analytics tool are output in different formats via the analytics tool and the different analytics tool.

16. A method as described in claim 13, wherein the analytics tools exposed by the cloud reporting platform include at least one of:
a freeform query and segmentation tool;
a path and sequencing tool;
an anomaly detection tool;
a contribution analysis tool; or
a cohort analysis tool.

17. A system implemented in a digital medium environment in which sensors are included as part of objects, detect usage events that result from object usage, and produce sensor data indicative of the usage events, the system configured to efficiently aggregate the sensor data and accurately make a determination of object usage from the aggregated sensor data to provide information regarding the object usage via analytics tools of a cloud reporting platform, the system comprising:
one or more processors; and
memory having stored thereon instructions that are executable by the one or more processors to implement the cloud reporting platform to perform operations comprising:
exposing the analytics tools to provide the information regarding the object usage;
determining usage of an object from aggregated usage data, the aggregated usage data converted from sensor data obtained from one or more sensors of the object into the aggregated usage data that is aggregated with other usage data of the object; and
communicating information describing the determined usage to a user device for output via an analytics tool used to request the information regarding the usage of the object.

18. A system as described in claim 17, wherein the operations further comprise obtaining the sensor data from the one or more sensors of the object.

19. A system as described in claim 17, wherein the operations further comprise maintaining the aggregated usage data in the cloud reporting platform.

20. A system as described in claim 17, wherein the analytics tools are exposed by the cloud reporting platform via a web page that enables users to access the analytics tools with browser applications.
